(19) United States
(12) Patent Application Publication
(10) Pub. No.: US 2020/0043113 A1
(43) Pub. Date: Feb. 6, 2020

(54) System for Dynamically Evaluating the Fairness of Contract Terms

(71) Applicant: Hu-manity Rights, Inc., Sparta, NJ (US)

(72) Inventors: Michael Jason DePalma, Morristown, NJ (US); Dharmendra Etwaru, Sparta, NJ (US)

(21) Appl. No.: 16/528,718

(22) Filed: Aug. 1, 2019

Related U.S. Application Data
(60) Provisional application No. 62/713,242, filed on Aug. 1, 2018.

(51) Int. Cl. G06Q 50/18; G06F 16/182; G06F 17/27

(52) U.S. Cl. CPC G06Q 50/188; G06F 17/2775; G06F 16/182

(57) ABSTRACT

A system for evaluating a contract includes a computing device and a computer-readable storage medium. The computer-readable storage medium includes programming instructions that, when executed, cause the computing device to receive an indication that a clause of a contract is suggested to be negotiated, determine whether the contract has been executed, in response to determining that the contract has been executed, prompt the consumer to specify how the consumer would have preferred the clause to have been negotiated, receive input from the consumer comprising one or more proposed changes to the clause, and store at least a portion of the received input as part of a blockchain so that it is associated with the contract and the clause to which it pertains, wherein at least a portion of information stored in the blockchain is publicly available to one or more third parties.

### CROSS-REFERENCE TO RELATED APPLICATIONS

This application claims priority to U.S. Patent Application No. 62/713,242, filed Aug. 1, 2018, the disclosure of which is incorporated by reference herein in its entirety.

### BACKGROUND

The present disclosure relates to an improved system for evaluating legal contract language to determine the extent to which the language is fair and balanced. The system uses this information to determine the viability of modifying the contract language to establish a new balance of fairness between the parties, and then implementing or proposing certain modifications to the contract language to establish such a new balance of fairness between the parties.

Whereas contract review, revision, redlining and re-negotiation is an expected component of business-to-business (B2B) contracting, business-to-consumer (B2C) contracts are notoriously lacking this ability, leaving individuals/consumers with a binary choice when engaging with digital contracts: either accept as written, or do not accept. In reality, consumers may wish some degree of control over specific language, such as how a business may or may not use the consumer's data. The system described in this disclosure provides a consumer the ability to minimally record their desires to a blockchain data structure. Even if not immediately binding, these records may provide a record of sentiment for B2C contracts going forward. At scale, these sentiments may be used to move markets and contracts towards a more fair and equitable set of solutions where the balance of power is not solely in the favor of corporations.

### SUMMARY

In an embodiment, a system for evaluating a contract includes a computing device, and a computer-readable storage medium. The computer-readable storage medium includes one or more programming instructions that, when executed, cause the computing device to receive an indication that a clause of a contract is suggested to be negotiated, where the contract is between a business and a consumer, determine whether the contract has been executed, in response to determining that the contract has been executed, prompt the consumer to specify how the consumer would have preferred the clause to have been negotiated, receive input from the consumer comprising one or more proposed changes to the clause, and store at least a portion of the received input as part of a blockchain so that it is associated with the contract and the clause to which it pertains, wherein at least a portion of information stored in the blockchain is publicly available to one or more third parties.

Optionally, the system may cause a renegotiation mechanism to be displayed. The renegotiation mechanism may allow the consumer to choose one or more of the following: a consumer-friendly interpretation of the clause, a business-friendly interpretation of the clause, or a balanced interpretation of the clause.

In an embodiment, a system for evaluating a contract may include a computing device, and a computer-readable storage medium. The computer-readable storage medium includes one or more programming instructions that, when executed, cause the computing device to receive an indication that a clause of a contract is suggested to be negotiated, where the contract is between a business and a consumer, and has one or more terms, determine whether the contract has been executed, in response to determining that the contract has not been executed, cause a renegotiation mechanism to be displayed to a user via a display of a client electronic device such that the renegotiation mechanism is displayed in proximity to the one or more terms, receive input from the consumer via the renegotiation mechanism, where the input indicates whether the consumer prefers a business-friendly interpretation of the terms, a consumer-friendly interpretation of the clause, or a balanced interpretation of the clause, and store at least a portion of the received input as part of a blockchain so that it is associated with the contract and the clause to which it pertains. At least a portion of information stored in the blockchain is publicly available to one or more third parties.

Optionally, the system may receive, by a language evaluation system, at least a portion of the contract that includes the clause, identify the clause, and determine a fairness value associated with the clause, wherein the fairness value represents how balanced one or more terms of the clause are between the business and the consumer.

The system may receive information from one or more data stores in communication with the language evaluation system, and compare at least a portion of the received information to the one or more terms.

In response to the fairness value indicating a business-friendly interpretation of the one or more terms, the system may send the clause to a language modification system.

In various embodiments, the system may determine a likelihood that the clause can be negotiated. The system may receive information from one or more of the following: a historical data store comprising information about terms and conditions of one or more contracts that are similar to the contract, or an economic impact data store comprising information indicating whether one or more financial terms of the contract will be altered by negotiating the clause. The system may use the received information to generate a suggestion as to whether the clause should be negotiated, and send a notification to the computing device, wherein the notification comprises the suggestion.

### BRIEF DESCRIPTION OF THE DRAWINGS

FIG. 1 illustrates an example contract evaluation system according to an embodiment.

FIG. 2 illustrates an example method of evaluating a contract according to an embodiment.

FIG. 3 illustrates an example of a scale according to an embodiment.

FIG. 4 illustrates an example contract portion having a renegotiation mechanism according to an embodiment.

FIGS. 5A-5C illustrate example contract clauses and renegotiation mechanisms according to various embodiments.

FIG. 6 is a block diagram illustrating various internal hardware components of an imaging device, according to an embodiment.

### DETAILED DESCRIPTION

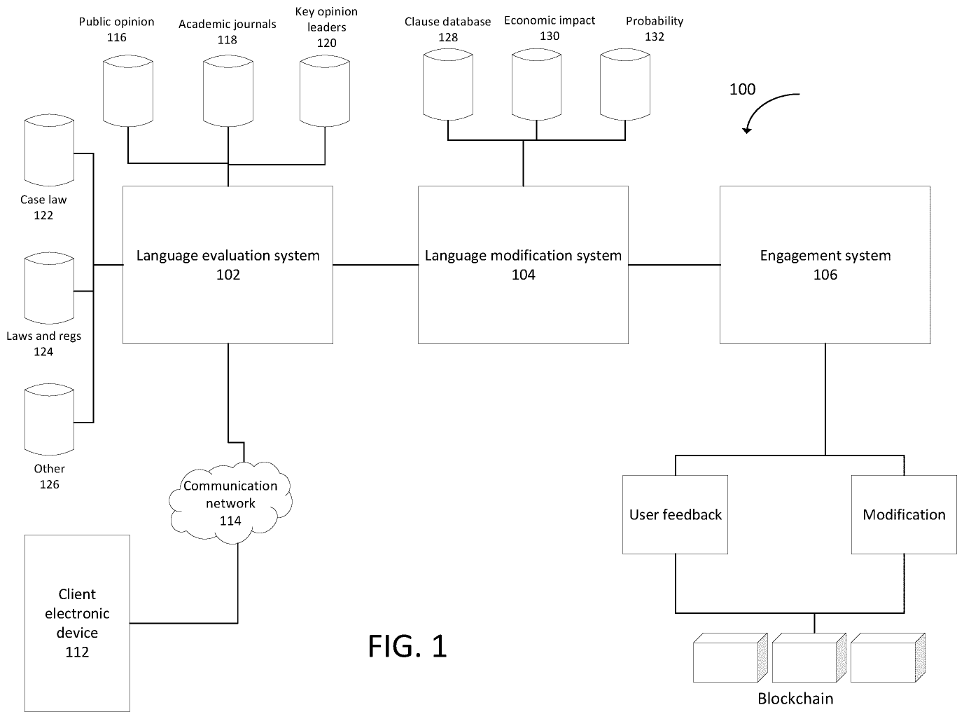

FIG. 1 illustrates an example contract evaluation system according to an embodiment. As illustrated by FIG. 1, a contract evaluation system 100 may include at least three subsystems: a language evaluation system 102, a language modification system 104, and an engagement system 106. As illustrated by FIG. 1, the language evaluation system 102 communicates with the language modification system 104. The language modification system 104 in turn communicates with the engagement system 106. In various embodiments, subsystems 102, 104, 106 may be components of the same electronic device, such as, for example, a server. In other embodiments, one or more of subsystems 102, 104, 106 may reside and/or operate remotely and/or independently from one or more of the other subsystems, and may communicate with one another via one or more communication networks. A communication network may be a local area network (LAN), a wide area network (WAN), a mobile or cellular communication network, an extranet, an intranet, the Internet and/or the like.

A language embodiment system may include one or more electronic devices configured to receive information from one or more sources, and determine, based on the received information, an indication of the relative fairness of a contract.

As illustrated in FIG. 1, a language evaluation system 102 may be in communication with one or more client electronic devices 112 via one or more communication networks 114. Examples of client electronic devices may include, without limitation, mobile phones, tablets, laptops, desktop computers and/or the like. As discussed in more detail below, a language evaluation system may receive a contract (or a portion of a contract) from a client electronic device to analyze. In certain embodiments, an application may reside on a client electronic device through which a consumer may initiate or participate in the contract evaluation process described in this disclosure.

A language evaluation system 102 may include, have access to or be in communication with one or more sources 116, 118, 120, 122, 124, 126. A source may be a data store that includes information of a particular nature or type. In some embodiments, a source may be part of a language evaluation system. In other embodiments, a source may reside remotely from a language evaluation system.

As illustrated by FIG. 1, a source 116, 118, 120, 122, 124, 126 may include information such as commentary or documentation of public opinion 116, academic journals 118, key opinion leaders 120, case law 122, and/or laws or regulations 124 about a topic, provision, clause or other contract language. Additional and/or alternate sources or types of information may be used within the scope of this disclosure. As described in more detail below, a language evaluation system may use at least a portion of information from one or more sources to analyze the terms of a received contract to determine an indication of how fair and balanced one or more provisions or terms of the contract are.

As shown in FIG. 1, a language modification system 104 may receive as input the output from a language evaluation system 102. This output, as explained in more detail below, may include one or more indications of the fairness of one or more provisions or terms of a contract.

A language modification system 104 may include, or be in communication with, one or more data stores such as, for instance, a clause data store 128, an impact data store 130 and a renegotiation data store 132. As explained in more detail below, information from one or more of these sources 128, 130, 132 may be applied to the input of the language modification system to yield a deployment decision. A deployment decision may refer to a recommendation or suggestion as to whether it is worthwhile for a consumer to renegotiate or consider renegotiating one or more terms of a contract.

As illustrated in FIG. 1, an engagement system may receive the deployment decision from the language modification system, and may use it to determine if and how to implement the decision. For instance, if the contract terms being considered are from an already executed or agreed to contract, the engagement system may receive consumer preferences on the clauses, and may log such preferences for future transactions. As another example, if the contract terms being considered are part of a new or unexecuted contract, the engagement system may generate proposed modifications to the contract terms. For instance, as described in more detail below, an engagement system may present one or more clauses (or language) to a consumer that may be modified, along with a mechanism (such as a slider) to change the effect of the clause or language.

A system for evaluating a contract, such as the one described above with respect to FIG. 1, may be implemented or used in a variety of ways. For instance, a contract may be loaded into the system for evaluation via a client electronic device. For instance, a business may provide a contract to the system for evaluation using a tablet, a laptop computer, and/or the like.

As another example, the system may evaluate a collection of contracts to identify potentially unfair ones, and to determine whether rebalancing of the terms may be feasible such as, for example, if accompanied by a commercial mode.

As another example, a business may use the system (or a portion of the system) to generate a “re-balanceable” version of a contract that it may make available to a consumer such as, for example on its website, through its mobile application and/or the like. The “re-balanceable” version may automatically be made available to a consumer. In other situations, a “re-balanceable” version of a contract may be offered to a consumer for the payment of a fee or upcharge.

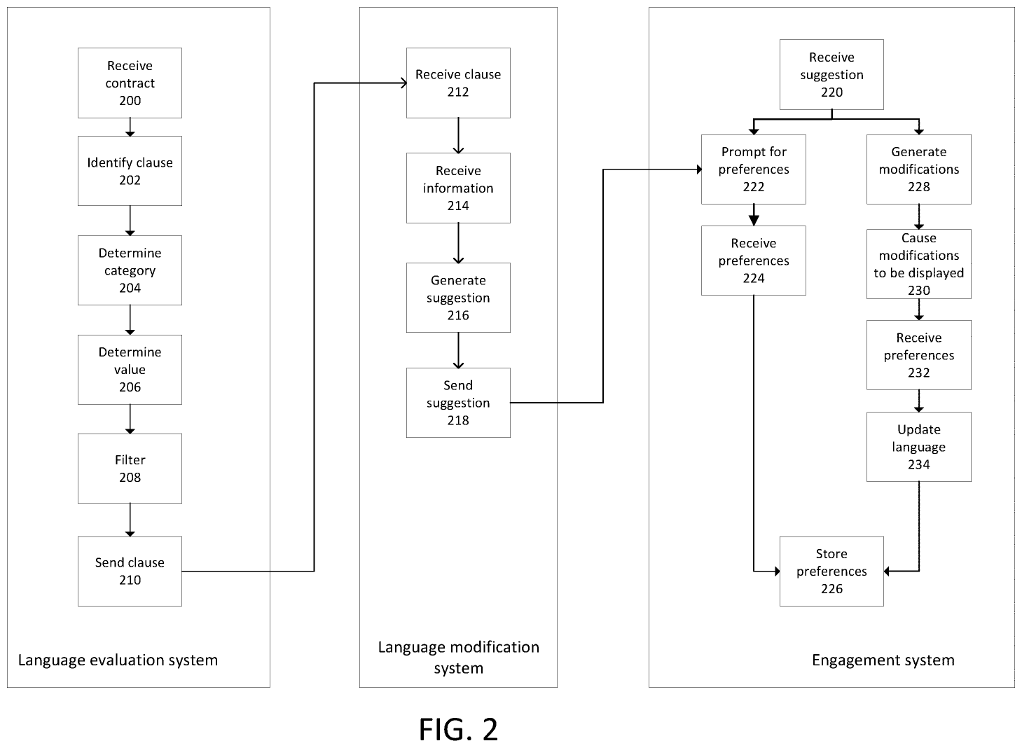

FIG. 2 illustrates an example method of evaluating a contract according to an embodiment. As shown in FIG. 2, a system may receive 200 at least a portion of a contract. A contract refers to a written agreement between two or more parties. In certain embodiments, a system may receive 200 an electronic version or representation of a contract. For instance, a contract may be one or more electronic files. In other embodiments, a contract may be a scanned or otherwise image processed representation of a document. A contract may include one or more terms and conditions, which may be set forth in one or more clauses or provisions. The terms and conditions may explain the obligations and responsibilities of the parties.

As illustrated by FIG. 2, a contract (or portion thereof) may be received 200 by a language evaluation system. A contract may be received from a client electronic device, an image capture device and/or the like. The language evaluation system may apply natural language processing (NPL) techniques to the contract to identify 202 one or more clauses. The language evaluation system may use NPL techniques to parse and understand the clause language itself. For instance, a language evaluation system may use NPL techniques to determine 204 a category to which a clause belongs. A category may refer to a portion of a contract to which a clause pertains, such as a heading, a section, a sub-section and/or the like. Example categories may include, for example, definitions, representations, warranties, indemnification, governing law and/or the like.

A language evaluation system may use NPL techniques to parse a clause to identify one or more words or phrases. A language evaluation system may compare one or more of the identified words to one or more words or phrases of a processing data store which are keyed to one or more categories to which they are likely to correspond. For instance, the words “represent” and “warrant” may be keyed to the category “representations.” Additional and/or alternate words, phrases and/or categories may be used within the scope of this disclosure.

Once a language evaluation system identifies a category to which a clause corresponds, the language evaluation system may determine 206 a value indicating how fair and balanced the clause is. For instance, a language evaluation system may parse a clause for language indicative of whether the clause is skewed in favor of one party over another. This language may include words or phrases such as, for example, “shall not”, “shall”, “must”, “must not”, “disclaim”, and/or the like.

In certain embodiments, in the case of B2C contracts, a language evaluation system may determine 206 a value indicating how fair and balanced a clause is to an individual consumer as compared to the business. Often B2C contracts, especially click through or similar contracts, include terms and conditions that heavily favor a business' interests over a consumer's interests.

A language evaluation system may determine 206 a value indicating how fair and balanced a clause is by evaluating at least a portion of information received from one or more sources against one or more contract terms. For example, a language evaluation system may generate an inference as to whether information received from one or more sources is in conflict with one or more contract terms. In an embodiment, a language evaluation system may generate an inference based on numeric variation between one or more contract terms and information from one or more sources. For example, a contract term may provide that liability under the contract is capped at the amount paid by the consumer to the business during the prior six months. A language evaluation system may receive information from one or more academic journal sources (or other sources), indicating that it is customary to cap a limitation of liability for that particular type of contract at the amounts paid during the prior twelve months rather than six.

In an embodiment, a language evaluation system may generate an inference based on an explicit language comparison. For instance, a system may compare identified contract terms to language from one or more sources to infer whether they are consistent or inconsistent with one another. In other embodiments, a language evaluation system may generate an inference based on an intent of a contract. A language evaluation system may receive input from a user, such as an administrator, in order to generate an inference based on intent.

In various embodiments, the value generated by the language evaluation system may be indicative of how consistent one or more contract terms are with the consulted sources. For instance, a value may have a value on a scale where values on the lower end of the scale indicate a higher degree of consistency with information received from one or more sources, and therefore a higher likelihood that the term is “fair.” Conversely, values on the higher end of the scale may indicate a lower degree of consistency with information received from one or more sources, and therefore a lower likelihood that the term is “fair.” As another example, the value generated may be a binary value representing “fair” or “unfair.” Additional and/or alternate values or ranges of values may be used within the scope of this disclosure.

Referring back to FIG. 2, a language evaluation system may filter 208 one or more clauses of a contract based on its determined value. For example, clauses associated with a value that exceeds a threshold value may be filtered into an “unfair” category, meaning that the terms of these clauses are heavily skewed in favor of a business and not an individual. As another example, clauses that are associated with a value that does not exceed a threshold value may be filtered as “fair”, meaning that the terms and conditions of these clauses are generally balanced between the parties.

In various embodiments, a language evaluation system may send 210 one or more clauses identified as “unfair” or “unbalanced” to a language modification system. The language modification system may receive 212 the one or more clause(s), and may process them to determine, for each, a likelihood that the clause can be negotiated.

A language modification system may receive 214 information from one or more sources that it may use to determine a likelihood that a clause can be negotiated. For example, a language modification system may receive information from a historical data store. A historical data store may store information about past attempts to negotiate the same or similar clause, such as, for example, an indication of whether a past attempt at negotiation was successful.

In other embodiments, a historical data store may store information about terms and conditions of one or more similar contracts. A contract may be considered similar to another contract if it pertains to products or services of a business of a similar size and/or in a similar industry. A system may use such information to determine how imbalanced a contract is as compared to other similar agreements. For instance, a historical data store may store one or more terms and conditions of a contract that are keyed to one or more categories pertaining to the contract such as business type (e.g., startup, early stage, Fortune 500, etc.) and/or industry (e.g., consumer goods, e-commerce, media, etc.). Additional and/or alternate categories may be used within the scope of this disclosure.

As another example, a language modification system may receive information from an economic impact data store. This information may include information indicating whether one or more financial terms of a contract may be altered by negotiating a particular clause. For instance, an economic impact data store may store information indicating that negotiating a higher cap indemnification cap may cause the cost of the contract to increase.

As discussed in more detail below, consumer input or preferences regarding terms of contracts may be stored on a blockchain. In various embodiments, a language modification system may analyze information stored on the blockchain to determine a number or level of consumers who have considered the same or similar terms as unfair, and may use this information to inform its analysis. For example, if a large number of other consumers have indicated that they consider the same or similar clause to be unfair, a language modification system may suggest renegotiating the clause.

In various embodiments, a language modification system may utilize machine learning techniques and methodologies to process the received information and generate 216 a suggestion as to whether a clause should be negotiated. In some embodiments, a language modification system may receive user input, such as from a system administrator, that may be used to generate a suggestion.

If the suggestion is for negotiation, a language modification system may send 218 a notification to an engagement system, which may receive 220 the notification. The notification may include the suggestion and/or information about the contract. For instance, the language processing system may send the engagement system an indication of the clause (or language) at issue, whether the contract has been executed (or acknowledged or finalized) or not and/or the like.

If the contract has already been executed, the engagement system may prompt 222 a consumer for preferences regarding the clause. For example, the engagement system may ask a consumer whether the consumer would have preferred to negotiate this clause if the consumer believed he or she could have. The engagement system may ask a consumer whether the consumer would have paid a higher contract amount if the clause could have been written more favorably to the consumer. Preferences may also include proposed new or updated terms to an agreement. For instance, preferences may include an indication of whether the consumer would have preferred a consumer-friendly interpretation of a clause, a business-friendly interpretation of a clause, or a balanced interpretation of a clause.

The engagement system may receive 224 one or more preferences from the consumer. The engagement system may store 226 these preferences as part of a blockchain. A consumer may also be able to see how many other consumers have indicated their desire to rebalance a contract, and therefore see what the crowd's attitude is toward the contract.

For instance, the preferences may be stored as a new block of a blockchain. While blockchain technology is commonly associated with cryptocurrency, it may also provide a vehicle for organizing and aligning vast numbers of consumers around a specified term, condition or agreement so that the power of the group can be leveraged to effect change. While cryptocurrencies have allowed people to agree on what something is (i.e., a unit of currency), blockchain may also be used to allow people to agree on how a term, condition, provision or contract should be interpreted.

A blockchain may store preferences from consumers regarding the fairness of one or more provisions of one or more contracts. In certain embodiments, the information stored in the blockchain may be de-identified so that it is not evident which consumer provided which preferences. In other embodiments, the information may be stored and correlated to a unique identifier associated with the consumer. The blockchain may be publicly accessible so that third parties can review and query at least a portion of information stored in the blockchain. For instance, a business looking to create or revise a contract may review consumer preferences regarding one or more clauses to anticipate how the clause will be received. In addition, this blockchain may be used as a competitive tool between businesses. For instance, a standards, audit or compliance body may access the blockchain to see which businesses have customers seeking collective renegotiation.

In various embodiments, only certain information may be publicly available via a blockchain. For example, information stored in a blockchain may be encrypted using asymmetric encryption techniques. A portion of the encrypted information may be available to those having a corresponding public key, while another portion of the encrypted information may be available to those possessing the corresponding private key. For example, a business may be able to access a blockchain with a public key to see how many consumers have elected to renegotiate its standard terms and conditions. However, the business may not be able to see details around the proposed renegotiations (e.g., how a consumer prefers to renegotiate a provision) without a private key, which may be provided to the business by a system provider.

If the contract has not already been executed, the engagement system may generate 228 one or more modifications to the contract pertaining to the clause(s) at issue, and cause 230 these modifications to be displayed to a consumer. In an embodiment, a modification may include displaying a renegotiation mechanism along with the contract, or a portion of the contract, such as the clause at issue. A renegotiation mechanism may be displayed as part of the contract such as, for example, below a clause at issue. In other embodiments, a renegotiation mechanism may be displayed as an overlay to a contract so that the renegotiation mechanism is displayed in proximity to the clause at issue.

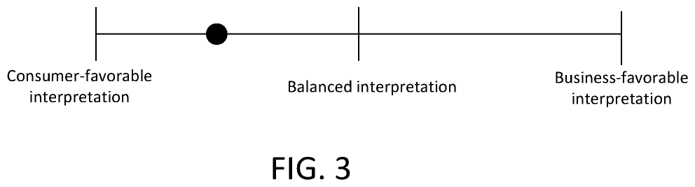

For instance, an engagement system may generate a scale that is applied to one or more clauses in the contract. FIG. 3 illustrates an example of a scale according to an embodiment. As illustrated by FIG. 3, the scale may include a sliding option for a consumer to customize the clause. The scale may cover a range of language interpretation options. As illustrated by FIG. 3, the range of options may scale from a business leaning interpretation to a consumer leaning interpretation. As shown in FIG. 3, the middle of the scale may represent a balanced interpretation.

Although FIG. 3 illustrates a sliding scale option, it is understood that additional and/or alternate renegotiation mechanisms may be used within the scope of this disclosure. For example, various menus, dropdowns, checkboxes, fields, and/or the like may be used to indicate a consumer's preferences regarding the interpretation and/or scope of one or more contract clauses.

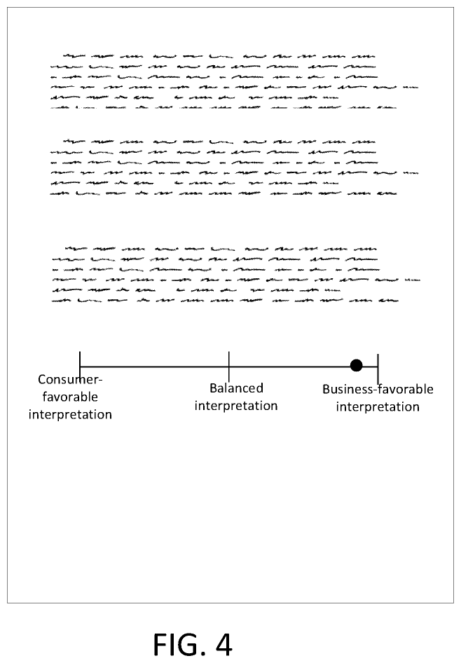

FIG. 4 illustrates an example contract portion having the renegotiation mechanism displayed in FIG. 3 according to an embodiment. As illustrated in FIG. 4, the system has modified the contract so that the renegotiation mechanism is displayed.

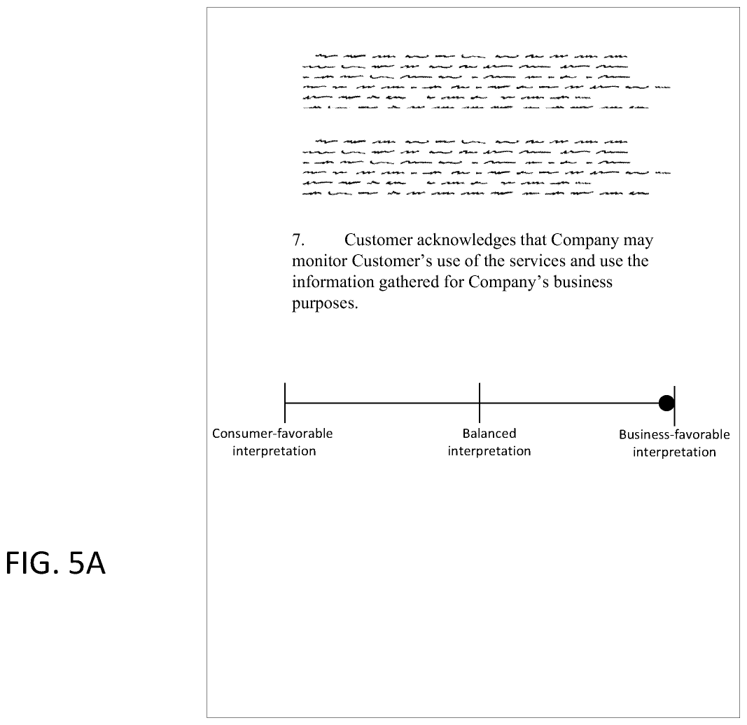

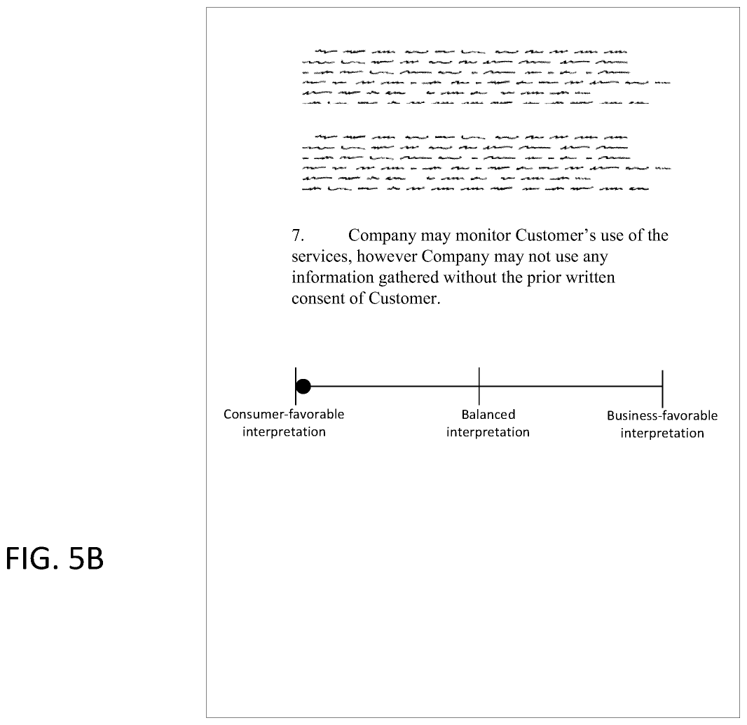

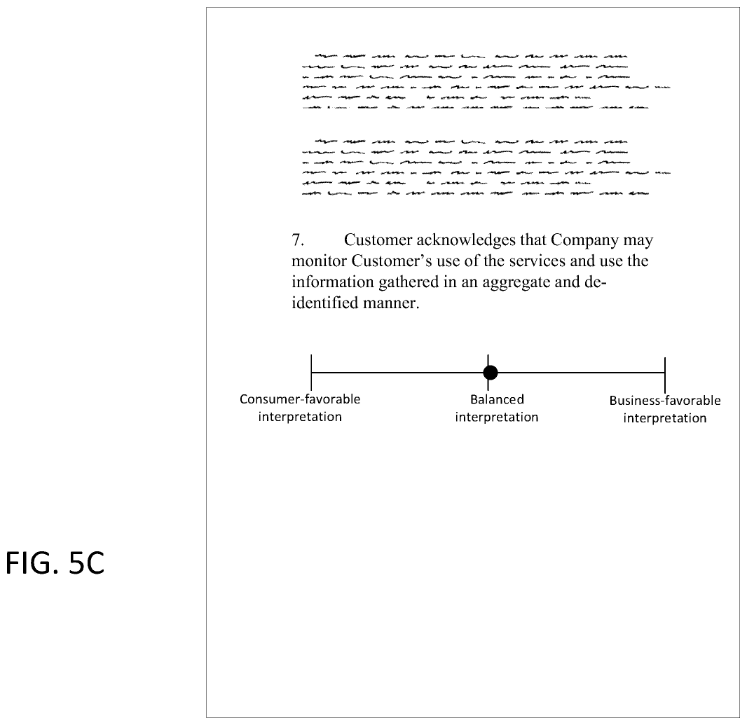

Referring back to FIG. 2, an engagement system may receive 232 input from a consumer via a displayed renegotiation mechanism. For instance, referring to FIG. 3, a consumer may adjust the sliding scale associated with a clause, and an engagement system may receive 232 this preference. In various embodiments, the engagement system may update 234 the language of one or more clauses of a contract in response to receiving consumer preferences. For instance, FIG. 5A illustrates an example contract clause and renegotiation mechanism according to an embodiment. If a consumer adjusts the renegotiation mechanism as illustrated in FIG. 5B (to have a more consumer-friendly interpretation), the clause language may be updated to read as illustrated in 5B. If a consumer adjusts the renegotiation mechanism as illustrated in FIG. 5C (to have a more fair and balanced interpretation), the clause language may be updated to read as illustrated in 5C.

In various embodiments, an update to a certain contract clause may trigger another update to a different contract clause. For instance, a consumer may select a more consumer-friendly interpretation for a clause, which may trigger an increase in the contract price. Additional and/or alternate updates may be used within the scope of this disclosure.

In an embodiment, an engagement system may include or be in communication with an update data store. An update data store may be used to dynamically update language of a contract based on a consumer's input to a renegotiation mechanism. For instance, an update data store may store one or more modifications to language of a contract that are to be made keyed to a particular consumer input. For instance, an update data store may store a particular consumer input (or range of consumer input), and corresponding updated contract language. When an engagement system receives a preference from a consumer, the engagement system may search an update data store for updated contract language that corresponds to the received preference, and may cause the updated contract language to be displayed to the consumer. The updates may be displayed in a different manner than the language of the contract that was not updated, such as, for example, in a different color text, in a different format or as a redline/compare view.

In various embodiments, at least a portion of the changes made to a contract may be stored 236 by an engagement system. In certain embodiments, the consumer preferences and/or changes/updates to a contract may be stored in a blockchain as described above.

In this document: (i) the term “comprising” means “including, but not limited to”; the singular forms “a,” “an,” and “the” include plural references unless the context clearly dictates otherwise; and (iii) unless defined otherwise, all technical and scientific terms used in this document have the same meanings as commonly understood by one of ordinary skill in the art. Also, terms such as “top” and “bottom”, “above” and “below”, and other terms describing position are intended to have their relative meanings rather than their absolute meanings with respect to ground. For example, one structure may be “above” a second structure if the two structures are side by side and the first structure appears to cover the second structure from the point of view of a viewer (i.e., the viewer could be closer to the first structure).

A “business” refers to a company, corporation, entity or other organization that may provide goods and/or services to a consumer pursuant to a B2C contract.

A “consumer” refers to an individual who may contract with a business for the provision of goods and/or services pursuant to a B2C contract.

An “electronic device” or a “computing device” refers to a device that includes a processor and memory. Each device may have its own processor and/or memory, or the processor and/or memory may be shared with other devices as in a virtual machine or container arrangement. The memory will contain or receive programming instructions that, when executed by the processor, cause the electronic device to perform one or more operations according to the programming instructions. Examples of electronic devices include personal computers, servers, mainframes, virtual machines, containers, gaming systems, televisions, and mobile electronic devices such as smartphones, personal digital assistants, cameras, tablet computers, laptop computers, media players and the like. In a client-server arrangement, the client device and the server are electronic devices, in which the server contains instructions and/or data that the client device accesses via one or more communications links in one or more communications networks. The server may be a single device or a collection of devices that are distributed but via which processing devices and/or memory are shared. In a virtual machine arrangement, a server may be an electronic device, and each virtual machine or container may also be considered to be an electronic device. In the discussion below, a client device, server device, virtual machine or container may be referred to simply as a “device” for brevity.

In this document, the terms “memory,” “memory device,” “data store,” “data storage facility” and the like each refer to a non-transitory device on which computer-readable data, programming instructions or both are stored. Except where specifically stated otherwise, the terms “memory,” “memory device,” “data store,” “data storage facility” and the like are intended to include single device embodiments, embodiments in which multiple memory devices together or collectively store a set of data or instructions, as well as individual sectors within such devices.

In this document, the terms “processor” and “processing device” refer to a hardware component of an electronic device that is configured to execute programming instructions. Except where specifically stated otherwise, the singular term “processor” or “processing device” is intended to include both single-processing device embodiments and embodiments in which multiple processing devices together or collectively perform a process.

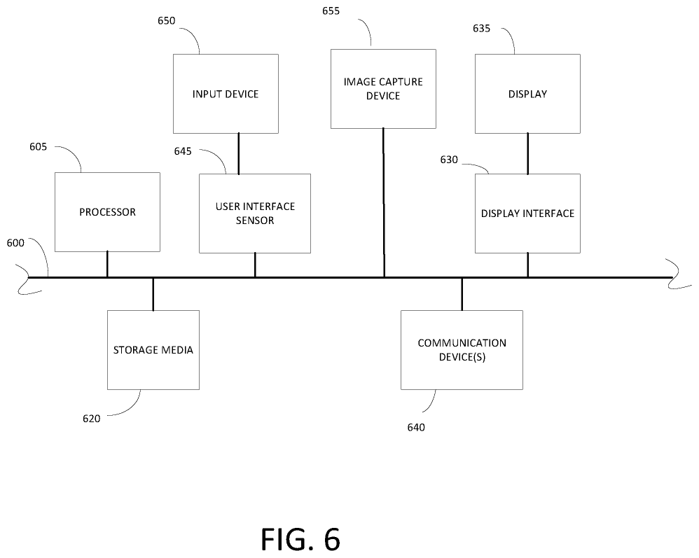

FIG. 6 depicts an example of internal hardware that may be included in any of the electronic components of the integrated imaging system and/or hardware that may be used to contain or implement program instructions. A bus 600 serves as the main information highway interconnecting the other illustrated components of the hardware. CPU 605 is the central processing unit of the system, performing calculations and logic operations required to execute a program. CPU 605, alone or in conjunction with one or more of the other elements disclosed in FIG. 6, is an example of a processor as such term is used within this disclosure. Read only memory (ROM) and random access memory (RAM) constitute examples of non-transitory computer-readable storage media 620, memory devices or data stores as such terms are used within this disclosure.

Program instructions, software or interactive modules for providing the interface and performing any querying or analysis associated with one or more data sets may be stored in the computer-readable storage media 620. Optionally, the program instructions may be stored on a tangible, non-transitory computer-readable medium such as a compact disk, a digital disk, flash memory, a memory card, a USB drive, an optical disc storage medium and/or other recording medium.

An optional display interface 630 may permit information from the bus 600 to be displayed on the display 635 in audio, visual, graphic or alphanumeric format. Communication with external devices may occur using various communication ports 640. A communication port 640 may be attached to a communications network, such as the Internet or an intranet. In various embodiments, communication with external devices may occur via one or more short range communication protocols.

The hardware may also include an interface 645 which allows for receipt of data from input devices such as a keyboard or other input device 650 such as a mouse, a joystick, a touch screen, a remote control, a pointing device, a video input device and/or an audio input device. The hardware may also include an image capture device 655, which allows for receipt of images, documents (such as contracts), and/or the like. An image capture device 655 may include a scanning device, a camera, and/or the like.

The described features, structures, or characteristics may be combined in any suitable manner in one or more embodiments. In the following description, numerous specific details are provided, such as examples of agents, to provide a thorough understanding of the disclosed embodiments. One skilled in the relevant art will recognize, however, that the embodiments can be practiced without one or more of the specific details, or with other methods, components, materials, etc. In other instances, well-known structures, materials, or operations are not shown or described in detail to avoid obscuring aspects of the embodiments.

The above-disclosed features and functions, as well as alternatives, may be combined into many other different systems or applications. Various components may be implemented in hardware or software or embedded software. Various presently unforeseen or unanticipated alternatives, modifications, variations or improvements may be made by those skilled in the art, each of which is also intended to be encompassed by the disclosed embodiments.

1. A method of evaluating a contract, the method comprising:
by a computing device:
receiving an indication that a clause of a contract is suggested to be negotiated, wherein the contract is between a business and a consumer,
determining whether the contract has been executed,
in response to determining that the contract has been executed, prompting the consumer to specify how the consumer would have preferred the clause to have been negotiated,
receiving input from the consumer comprising one or more proposed changes to the clause, and
storing at least a portion of the received input as part of a blockchain so that it is associated with the contract and the clause to which it pertains, wherein at least a portion of information stored in the blockchain is publicly available to one or more third parties.

2. The method of claim 1, wherein prompting the consumer to specify how the clause should be negotiated comprises causing a renegotiation mechanism to be displayed, wherein the renegotiation mechanism allows the consumer to choose one or more of the following:
a consumer-friendly interpretation of the clause;
a business-friendly interpretation of the clause; or
a balanced interpretation of the clause.

3. A method of evaluating a contract, the method comprising:
by a computing device:
receiving an indication that a clause of a contract is suggested to be negotiated, wherein the contract is between a business and a consumer, wherein the clause comprises one or more terms,
determining whether the contract has been executed,
in response to determining that the contract has not been executed, causing a renegotiation mechanism to be displayed to a user via a display of a client electronic device such that the renegotiation mechanism is displayed in proximity to the one or more terms,
receiving input from the consumer via the renegotiation mechanism, wherein the input indicates whether the consumer prefers a business-friendly interpretation of the terms, a consumer-friendly interpretation of the clause, or a balanced interpretation of the clause, and
storing at least a portion of the received input as part of a blockchain so that it is associated with the contract and the clause to which it pertains, wherein at least a portion of information stored in the blockchain is publicly available to one or more third parties.

4. The method of claim 3, further comprising:
receiving, by a language evaluation system, at least a portion of the contract that includes the clause,
identifying the clause, and
determining a fairness value associated with the clause, wherein the fairness value represents how balanced one or more terms of the clause are between the business and the consumer.

5. The method of claim 4, wherein determining a fairness value associated with the clause comprises receiving information from one or more data stores in communication with the language evaluation system, and comparing at least a portion of the received information to the one or more terms.

6. The method of claim 4, further comprising:
in response to the fairness value indicating a business-friendly interpretation of the one or more terms, sending the clause to a language modification system.

7. The method of claim 6, further comprising determining a likelihood that the clause can be negotiated.

8. The method of claim 7, wherein determining a likelihood that the clause can be negotiated comprises:
receiving information from one or more of the following:
a historical data store comprising information about terms and conditions of one or more contracts that are similar to the contract, or
an economic impact data store comprising information indicating whether one or more financial terms of the contract will be altered by negotiating the clause;
using the received information to generate a suggestion as to whether the clause should be negotiated; and
sending a notification to the computing device, wherein the notification comprises the suggestion.

9. A system for evaluating a contract, the system comprising:
a computing device; and
a computer-readable storage medium comprising one or more programming instructions that, when executed, cause the computing device to:
receive an indication that a clause of a contract is suggested to be negotiated, wherein the contract is between a business and a consumer,
determine whether the contract has been executed,
in response to determining that the contract has been executed, prompt the consumer to specify how the consumer would have preferred the clause to have been negotiated,
receive input from the consumer comprising one or more proposed changes to the clause, and
store at least a portion of the received input as part of a blockchain so that it is associated with the contract and the clause to which it pertains, wherein at least a portion of information stored in the blockchain is publicly available to one or more third parties.

10. The system of claim 9, wherein the one or more programming instructions that, when executed, cause the computing device to prompt the consumer to specify how the clause should be negotiated comprise one or more programming instructions that, when executed, cause the computing device to cause a renegotiation mechanism to be displayed, wherein the renegotiation mechanism allows the consumer to choose one or more of the following:
a consumer-friendly interpretation of the clause;
a business-friendly interpretation of the clause; or
a balanced interpretation of the clause.

11. A system for evaluating a contract, the system comprising:
a computing device; and
a computer-readable storage medium comprising one or more programming instructions that, when executed, cause the computing device to:
receive an indication that a clause of a contract is suggested to be negotiated, wherein the contract is between a business and a consumer, wherein the clause comprises one or more terms,
determine whether the contract has been executed,
in response to determining that the contract has not been executed, cause a renegotiation mechanism to be displayed to a user via a display of a client electronic device such that the renegotiation mechanism is displayed in proximity to the one or more terms,
receive input from the consumer via the renegotiation mechanism, wherein the input indicates whether the consumer prefers a business-friendly interpretation of the terms, a consumer-friendly interpretation of the clause, or a balanced interpretation of the clause, and
store at least a portion of the received input as part of a blockchain so that it is associated with the contract and the clause to which it pertains, wherein at least a portion of information stored in the blockchain is publicly available to one or more third parties.

12. The system of claim 11, wherein the computer-readable storage medium further comprises one or more programming instructions that, when executed, cause the computing device to:
receive, by a language evaluation system, at least a portion of the contract that includes the clause,
identify the clause, and
determine a fairness value associated with the clause, wherein the fairness value represents how balanced one or more terms of the clause are between the business and the consumer.

13. The system of claim 12, wherein the one or more programming instructions that, when executed, cause the computing device to determine a fairness value associated with the clause comprise one or more programming instructions that, when executed, cause the computing device to receive information from one or more data stores in communication with the language evaluation system, and compare at least a portion of the received information to the one or more terms.

14. The system of claim 12, wherein the computer-readable storage medium further comprises one or more programming instructions that, when executed, cause the computing device to, in response to the fairness value indicating a business-friendly interpretation of the one or more terms, send the clause to a language modification system.

15. The system of claim 14, wherein the computer-readable storage medium further comprises one or more programming instructions that, when executed, cause the computing device to determine a likelihood that the clause can be negotiated.

16. The system of claim 15, wherein the one or more programming instructions that, when executed, cause the computing device to determine a likelihood that the clause can be negotiated comprise one or more programming instructions that, when executed, cause the computing device to:
receive information from one or more of the following:
a historical data store comprising information about terms and conditions of one or more contracts that are similar to the contract, or
an economic impact data store comprising information indicating whether one or more financial terms of the contract will be altered by negotiating the clause;
use the received information to generate a suggestion as to whether the clause should be negotiated; and
send a notification to the computing device, wherein the notification comprises the suggestion.
